(19) United States
(12) Patent Application Publication
(10) Pub. No.: US 2016/0092391 A1
(43) Pub. Date: Mar. 31, 2016

(54) INTERFACE APPARATUS, VEHICLE HAVING THE SAME, AND METHOD OF CONTROLLING THE SAME

(71) Applicant: HYUNDAI MOTOR COMPANY, Seoul (KR)

(72) Inventor: Sung Jun PARK, Hwaseong-si (KR)

(21) Appl. No.: 14/566,418

(22) Filed: Dec. 10, 2014

(30) Foreign Application Priority Data
Sep. 25, 2014 (KR) 10-2014-0128186

(51) Int. Cl. G06F 13/40; H04L 29/08; G06F 13/42

(52) U.S. Cl. CPC G06F 13/4081; G06F 13/4282; H04L 67/12

(57) ABSTRACT

An interface apparatus of communicating with a multimedia player includes a slot part into which a card type memory is inserted; a hub part connected to the slot part, and configured to switch a communication line of the card type memory to a USB communication line; a port part to which an external device allowing USB communications is connected; a first connector connected to the hub part, and configured to transmit data stored in the card type memory to the multimedia player; and a second connector connected to the port part, and configured to transmit data stored in the external device to the multimedia player. Since a slot part for card type memory, a USB port, and an AUX terminal are arranged together, it is possible to improve the commercial value and design of the multimedia player.

### CROSS-REFERENCE TO RELATED APPLICATION

This application claims the benefit of Korean Patent Application No. 2014-0128186, filed on Sep. 25, 2014 in the Korean Intellectual Property Office, the disclosure of which is incorporated herein by reference.

### BACKGROUND

1. Field

Present disclosure relates to an interface apparatus for communication between at least two apparatuses, a vehicle having the interface apparatus, and a method of controlling the interface apparatus.

2. Description of the Related Art

A vehicle includes a cluster that displays driving information and vehicle information, such as speed, Revolutions Per Minute (RPM), gauge, and cooling water. Generally, the vehicle further includes additional functions for a user's convenience, such as an audio play function, a video play function, a navigation function, air-conditioning control, seat position control, lighting control, etc., in addition to a driving function. Also, the vehicle includes various multimedia players, such as an audio system, a terminal, an Audio Video Navigation (AVN) system into which an audio play function, a video play function, and a navigation function are integrated, and the like, for a user's convenience.

Particularly, a user can connect a MPEG audio layer-3 (MP3) player, a Universal Serial Bus (USB) storage device, a mobile communication terminal, etc. to a multimedia player in a vehicle to reproduce data stored in the connected apparatus through the multimedia player. In order to reproduce the data stored in the connected apparatus, the multimedia player further includes an interface apparatus with a USB terminal or an auxiliary (AUX) terminal. The interface apparatus may further include a Secure Digital (SD) slot into which a SD storage device can be inserted.

The multimedia player reads data stored in a storage device inserted into the SD slot of the interface apparatus to execute a navigation function. Also, the multimedia player reads, when an external device is connected to the USB terminal or the AUX terminal of the interface apparatus, data stored in the external device and outputs the read data.

Lately, a multimedia player that communicates with a mobile communication terminal to execute a call function, a music play function, and a navigation function using data of the mobile communication terminal has been developed. However, when a mobile communication terminal is connected to the USB terminal of the interface apparatus, a host is changed from the multimedia player to the mobile communication terminal according to a specification, so that the multimedia player cannot read data of a storage device inserted into the SD slot. That is, since the multimedia player cannot read map data stored in the storage device inserted into the SD slot of the interface apparatus, the multimedia player cannot execute the navigation function.

### SUMMARY

In accordance with one aspect of the present disclosure, an interface apparatus of communicating with a multimedia player, includes: a slot part into which a card type memory is inserted; a hub part connected to the slot part, and configured to switch a communication line of the card type memory to a Universal Serial Bus (USB) communication line; a port part to which an external device allowing USB communications is connected; a first connector connected to the hub part, and configured to transmit data stored in the card type memory to the multimedia player; and a second connector connected to the port part, and configured to transmit data stored in the external device to the multimedia player.

Each of the first connector and the second connector may include a USB port having an independent USB communication line. The card type memory may be a Secure Digital (SD) card, and the slot part may include a SD slot. The first connector and the second connector may be connected to the multimedia player through a cable or a connector. The interface apparatus may further include a terminal part configured to receive and output an audio signal.

In accordance with another aspect of the present disclosure, a vehicle includes: a multimedia player; and an interface apparatus configured to transmit data to the multimedia player, wherein the interface apparatus includes: a slot part to which a card type memory storing map data is inserted; a hub part configured to switch a communication line of the slot part to a Universal Serial Bus (USB) communication line; and a first connector connected to the hub part, and configured to transmit data stored in the card type memory to the multimedia player.

The interface apparatus may include: a port part to which an external device allowing USB communications is connected; and a second connector connected to the port part, and configured to transmit data stored in the external device to the multimedia player. The multimedia player may include a controller configured to perform USB communications with the interface apparatus, to receive data through the USB communications, and to control operation of the multimedia player based on the received data.

The controller may include: a third connector connected to the first connector, and configured to receive data stored in the card type memory; a fourth connector connected to the second connector, and configured to receive data stored in the external device; and a micom configured to receive at least one data between the data stored in the card type memory and the data stored in the external device. The micom may control communications of the third connector and the fourth connector independently. The controller may further include a slot part into which the card type memory is inserted.

The multimedia player may execute at least one function among functions of the external device connected to the fourth connector. The multimedia player may be connected to the interface apparatus through a cable or a connector. The interface apparatus may further include a terminal part configured to receive and output an audio signal. The interface apparatus may be positioned in a center fascia to be adjacent to the multimedia player.

In accordance with still another aspect of the present disclosure, a method of controlling an interface apparatus to transmit data to a multimedia player installed in a vehicle, includes: if a navigation function is executed on the multimedia player, receiving map data stored in a card type memory through a Secure Digital (SD) communication line; and switching the SD communication line to a Universal Serial Bus (USB) communication line to transmit the map data to the multimedia player.

The method may further include, if an external device is connected to a port part of the interface apparatus when the multimedia player executes the navigation function, transmitting data stored in the external device to the multimedia player through another USB communication line. The transmitting of the data stored in the external device may include transmitting the data stored in the external device to the multimedia player so that at least one function among a plurality of functions that are executed on the external device is executed on the multimedia player.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 shows an example of the exterior of a vehicle in which an interface apparatus according to an embodiment of the present disclosure is installed;

FIG. 2 shows an example of the interior of a vehicle in which an interface apparatus according to an embodiment of the present disclosure is installed;

FIG. 3 shows an installation example of an interface apparatus according to an embodiment of the present disclosure;

FIG. 4 shows an example of the exterior of an interface apparatus according to an embodiment of the present disclosure;

FIG. 5 shows an example of a rear part of an interface apparatus according to an embodiment of the present disclosure;

FIG. 6 is a configuration view showing connections between an interface apparatus according to an embodiment of the present disclosure and a multimedia player;

FIG. 7 is a flowchart chart illustrating a method of controlling a vehicle in which an interface apparatus according to an embodiment of the present disclosure and a multimedia player are installed; and

FIGS. 8, 9, and 10 show examples of screens of a multimedia player and an external device that communicates with the multimedia player through an interface apparatus according to an embodiment of the present disclosure.

### DETAILED DESCRIPTION

It is an aspect of the present disclosure to provide an interface apparatus of reading data stored in a card type memory through a Secure Digital (SD) communication line and outputting the read data to a Universal Serial Bus (USB) communication line, a vehicle having the interface apparatus, and a method of controlling the interface apparatus.

It is another aspect of the present disclosure to provide an interface apparatus including a first connector and a second connector that perform USB communication independently, a vehicle having the interface apparatus, and a method of controlling the interface apparatus.

Additional aspects of the disclosure will be set forth in part in the description which follows and, in part, will be obvious from the description, or may be learned by practice of the disclosure. Reference will now be made in detail to the embodiments of the present disclosure, examples of which are illustrated in the accompanying drawings, wherein like reference numerals refer to like elements throughout.

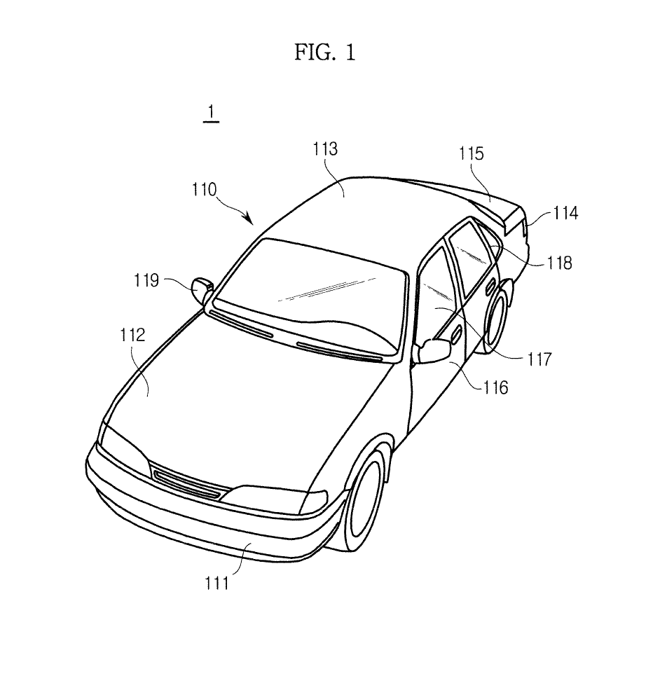

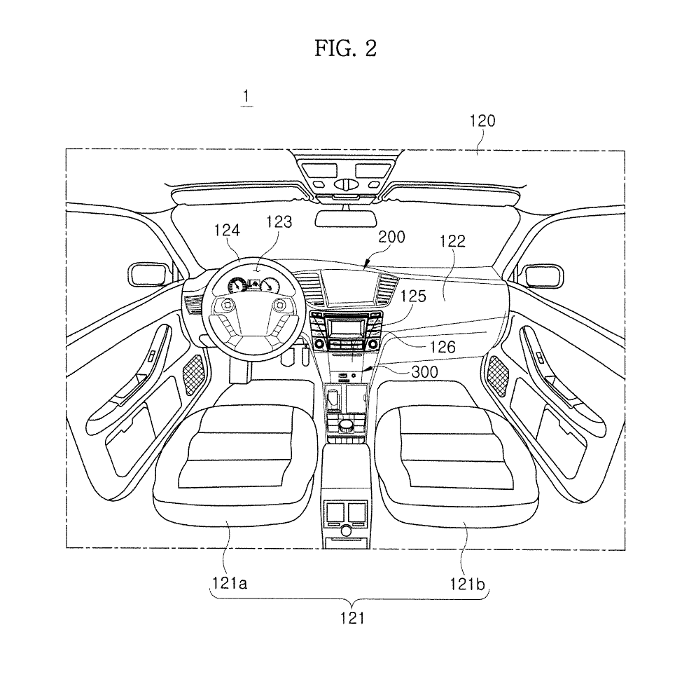

FIG. 1 shows an example of the exterior of a vehicle in which an interface apparatus according to an embodiment of the present disclosure is installed, and FIG. 2 shows an example of the interior of a vehicle in which an interface apparatus according to an embodiment of the present disclosure is installed.

The vehicle drives wheels to move on a road in order to carry persons or goods.

Referring to FIGS. 1 and 2, a vehicle 1 may include a body having an interior part 120 and an exterior part 110, and a chassis which is the remaining part except for the body and in which a mechanical system required for driving is installed.

As illustrated in FIG. 1, the exterior part 110 of the body may include a front panel 111, a hood 112, a loop panel 113, a rear panel 114, a trunk 115, and front, rear, left, and right doors 116. The exterior part 110 of the body may further include a plurality of window glasses 117 respectively installed in the front, rear, left, and right doors 116, and a plurality of window fillers 118 that are provided in borders between the front, rear, left, and right window glasses 117.

The exterior part 110 of the body may further include a plurality of quarter window glasses installed between the fillers 118 wherein the quarter window glasses do not open, a rear window glass installed in the back part of the body, and a front window glass installed in the front part of the body. The exterior part 110 of the body may further include a plurality of side mirrors 119 that provide a driver with rear views.

The chassis of the vehicle 1 may include a power generation system, a power transfer system, a driving system, a steering system, a brake system, a suspension system, a transmission system, a fuel system, and front, rear, left, and right wheels.

Also, the vehicle 1 may include various safety systems to ensure a driver and passengers' safety. The safety systems may include an airbag system to ensure a driver and passengers' safety upon collision, and an Electronic Stability Control (ESC) system to avoid loss of control of the vehicle 1 when the vehicle 1 accelerates or corners.

The vehicle 1 may further include a proximity sensor to sense an obstacle or another vehicle in the rear or side of the vehicle 1, and a rain sensor to determine whether it rains and to sense an amount of rainfall. The vehicle 1 may further include an Electronic Control Unit (ECU) to control the power generation system, the power transfer system, the driving system, the steering system, the brake system, the suspension system, the transmission system, the fuel system, the various safety systems, and the sensors.

Also, the vehicle 1 may optionally include electronic apparatuses, such as a hands-free system to improve a driver's convenience, a Global Positioning System (GPS), an audio system, a Bluetooth device, a rear camera, and a charging apparatus, and a High-pass apparatus. The vehicle 1 may further include a multimedia player 200 to execute a Digital Multimedia Broadcasting (DMB) function, an audio function, a video function, a navigation function, etc. That is, the multimedia player 200 that is installed in the vehicle 1 may be a navigation (or Audio Video Navigation (AVN)) system, or a terminal which has a communication function and in which a navigation application is installed.

The navigation system is equipment to calculate a current position of the vehicle 1 by receiving position information from satellites through a GPS, to map-match the calculated position with stored map data to display the results of the map-matching, to receive information about a destination from a user to search a route from the current position to the destination according to a predetermined route search algorithm, to match the found route with the map to display the resultant map, and to guide the user to arrive at the destination along the route. The navigation system may be fixedly installed on a dash board.

The multimedia player 200 may include an input unit to receive commands from a user, a display unit to display operation information, and a controller 250 to control operation of the display unit in response to the user's command. The display unit of the multimedia player 200 may be implemented with a flat display panel, such as a Liquid Crystal Display (LCD), a Plasma Display Panel (PDP), and an Organic Light Emitting Diode (OLED).

The input unit of the multimedia player 200 may be implemented in the form of a touch screen by further including a touch panel integrated with the flat display panel. That is, the input unit and the display unit of the multimedia player 200 may be implemented as a touch screen.

The controller 250 of the multimedia player 200 may use map data of a card type memory transmitted through the interface apparatus 300 to execute the navigation function.

Also, the multimedia player 200 may receive, when an external device is connected to the interface apparatus 300, data from the external device, and execute a function (that is, a Carplay function) of the external device based on the received data. The multimedia player 200 may execute at least one function among functions that are executed on a mobile communication terminal that is an external device.

The multimedia player 200 may receive, when a card type memory and an external device are connected to the interface apparatus 300, data stored in the card type memory and data stored in the external device, independently, and execute the corresponding function using the received data independently.

The vehicle 1 may further include a start button for inputting an operation command to a start motor (not shown). That is, when the start button is turned on, the vehicle 1 may operate the start motor to drive an engine (not shown) that is a power generation system, through the operation of the start motor.

The vehicle 1 may further include a battery (not shown) electrically connected to a terminal, the audio system, room lamps, the start motor, and other electronic devices to supply operating power to the electronic devices. The battery may charge the electronic devices using its own generator or engine power during driving.

As shown in FIG. 2, the interior part 120 of the vehicle 1 may include: a plurality of seats 121 in which passengers sit; a dash board 122; an instrument panel (that is, a cluster) 123 which is disposed on the dash board 122 and in which a tachometer, a speed meter, a cooling water thermometer, a fuel gauge, a turn signal indicator, a high beam indicator, an alarm lamp, a seat belt warning lamp, a trip odometer, an odometer, an automatic transmission selection lever indicator, an opening-of-door warning indicator, an engine oil alarm lamp, and a fuel shortage alarm lamp are arranged; a steering wheel 124 to control a movement direction of the vehicle 1; and a center fascia 125 including an audio system and blades of an air conditioner.

The seats 121 may include a driver seat 121a in which a driver sits, a passenger seat 12b in which a passenger sits, and a back seat that is provided in the back part inside the vehicle 1.

The cluster 123 may be implemented in a digital fashion. The cluster 123 implemented in the digital fashion may display vehicle information and driving information in the form of images.

The center fascia 125 may be located in the dashboard 122 between the driver seat 121a and the passenger seat 121b, and include a head unit 126 to control the audio system, the air conditioner, seat heaters, and the like. In the center fascia 125, a ventilator, a cigar jack, and the like may be installed. Also, the center fascia 125 may include the interface apparatus 300 to perform data communication between the multimedia player 200 and an external device 400.

The interface apparatus 300 may be disposed adjacent to the head unit 126 and the multimedia player 200. The interface apparatus 300 may be electrically connected to the multimedia player 200 through a connector or a cable.

The external device 400 may be a storage device, a mobile communication terminal, or a MPEG audio layer-3 (MP3) player. The storage device may be a card type memory or an external hard disk, and the mobile terminal may be a smart phone, a notebook computer, or a tablet computer.

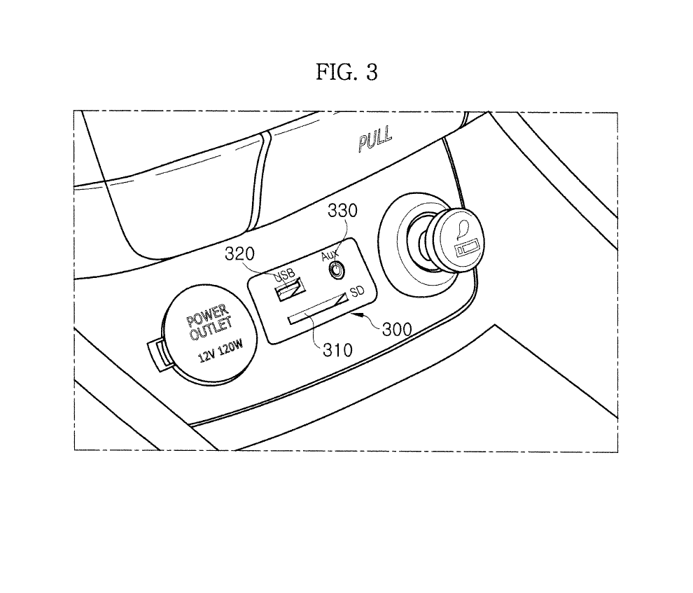

As shown in FIG. 3, the interface apparatus 300 may include a slot part 310 into which a Secure Digital (SD) card as a card type memory is inserted, a port part 320 to which a USB port of an external device allowing USB communications is connected, and a terminal part 330 to which a terminal of an auxiliary (AUX) cable of an external device for reproducing audio files is connected.

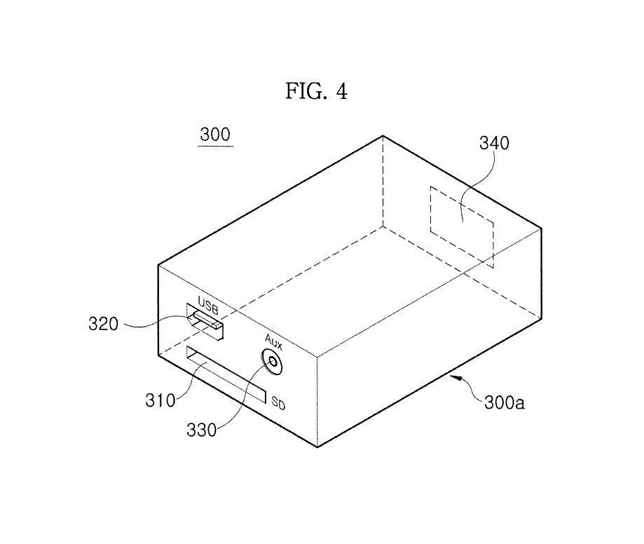

As shown in FIG. 4, the interface apparatus 300 may have a main body 300a forming an external appearance, wherein the slot part 310, the port part 320, and the terminal part 330 may be arranged in the main body 300a. The interface apparatus 300 may further include a connector part 340 to transfer data stored in a card type memory inserted into the slot part 310 to the multimedia player 200, and to transfer data stored in an external device connected to the port part 320 to the multimedia player 200.

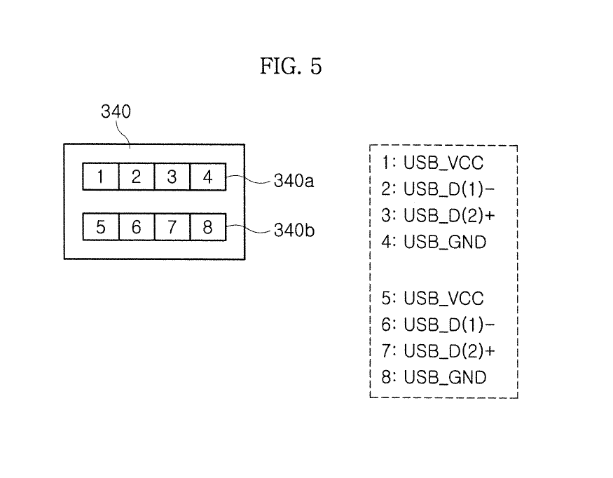

As shown in FIG. 5, the connector part 340 may include a first connector 340a to transfer data stored in a card type memory to the multimedia player 200, and a second connector 340b to transfer data stored in an external device to the multimedia player 200. The first connector 340a and the second connector 340b, which are USB ports, may be separated from each other so as to perform independent communications although they are arranged adjacent to each other. The first connector 340a and the second connector 340b may be respectively connected to connectors of the multimedia player 200. Each of the first connector 340a and the second connector 340b may include a voltage terminal Vcc, a minus (−) data terminal D(1)−, a plus (+) data terminal D(1)+, and a ground terminal GND.

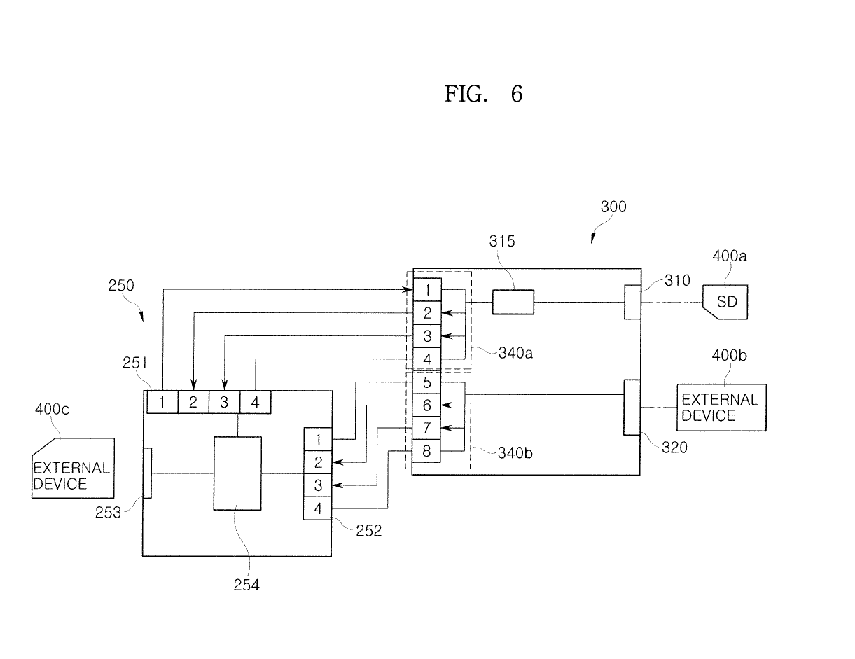

The interface apparatus 300 will be described in more detail with reference to FIG. 6, below. The interface apparatus 300 may include the slot part 310, a hub part 315, the port part 320, the terminal part 330, and the connector part 340.

The slot part 310 may be a slot into which a SD card 400a as a card type memory is inserted, and may transfer data stored in the SD card 400a to the hub part 315 through a SD communication line. The SD card 400a as a card type memory may store map data needed to execute a navigation function. The SD card 400a can be withdrawn from the slot part 310, and the stored map data can be updated.

The slot part 310 may read, when the multimedia player 200 executes the navigation function, the map data stored in the SD card 400a, and output the map data to the SD communication line.

The hub part 315 may be positioned between the slot part 310 and the first connector 340a. The hub part 315 may connect to the slot part 310 through a SD communication line, and connect to the first connector 340a through a USB communication line. Accordingly, if data stored in the SD card 400a is received through the SD communication line, the hub part 315 may switch the SD communication line to the USB communication line to transfer the received data to the first connector 340a through the USB communication line.

The hub part 315 enables bidirectional communications. By arranging the slot part 310 for card type memory and the hub part 315 in the interface apparatus 300 in this way, the slot part 310 and the hub part 315 can be designed to be within a distance of 200 mm. In addition, since an expensive cable for card type memory is not required, manufacturing costs can be effectively reduced.

The port part 320, to which a mobile communication terminal 400b as an external device is connected, may connect to the mobile communication terminal 400b through a USB cable, and transfer data stored in the mobile communication terminal 400b to the second connector 340b. The mobile communication terminal 400b, which allows USB communications, may include a USB port, and if one end of the UBS cable is connected to the USB port, the mobile communication terminal 400b may output data stored therein to the multimedia player 200 through the USB cable. That is, the mobile communication terminal 400b may connect to the multimedia player 200 in the vehicle 1 through USB communications.

The mobile communication terminal 400b may be a smart phone or a tablet computer, having at least one application, and transfer data to the multimedia player 200 so that the at least one application can be executed on the multimedia player 200 that is another apparatus.

Operation in which an application of the mobile communication terminal 400b is executed on the multimedia player 200 is mirroring of sending a screen of the mobile communication terminal 400b to the display unit of the multimedia player 200 in the vehicle 1, wherein the display unit of the multimedia player 200 in the vehicle 1 executes only the display function, and actual execution of the application, data processing, and communication are executed on the mobile communication terminal 400b. That is, the mobile communication terminal 400b may transmit only a function usable in the vehicle 1 to the display unit of the multimedia player 200, instead of transmitting the screen of the mobile communication terminal 400b as it is to the multimedia player 200.

The terminal part 330 may be an AUX terminal to which an AUX cable connected to an external device for reproducing audio files is connected. The terminal part 330 may transmit audio data stored in an external device connected to the AUX cable to the multimedia player 200 or to an audio system (not shown) of the vehicle 1 so that the audio data can be reproduced.

The connector part 340 may include the first connector 340a to transfer data stored in the card type memory 400a, and the second connector 340b to transfer data stored in the external device 400b, as described above. The first connector 340a and the second connector 340b may include USB ports, respectively, and transfer data stored in the card type memory 400a and data stored in the external device 400b, respectively, to the controller 250 of the multimedia player 200.

The first connector 340a and the second connector 340b may connect to the connectors of the multimedia player 200 through the respective USB cables, and may connect directly to the multimedia player 200 through the respective USB ports.

The first connector 340a may connect to a third connector 251 of the multimedia player 200, and the second connector 340b may connect to a fourth connector 252 of the multimedia player 200. Accordingly, the first connector 340a may transfer data stored in the card type memory 400a to the third connector 251 of the multimedia player 200, and the second connector 340b may transfer data stored in the external device 400b to the fourth connector 252 of the multimedia player 200. The first connector 340a and the second connector 340b may transmit data to the multimedia player 200 through different USB communication lines.

The controller 250 of the multimedia player 200 may include the third connector 251, the fourth connector 252, a slot part 253, and a micom 254. The third connector 251 and the fourth connector 252 may include USB ports. The third connector 251 may connect to the first connector 340a of the interface apparatus 300, and the fourth connector 252 may connect to the second connector 340b of the interface apparatus 300.

Accordingly, the third connector 251 may receive data stored in the card type memory 400a to transmit the data to the micom 254, and the fourth connector 252 may receive data stored in the external device 400b to transmit the data to the micom 254. As such, the third connector 251 and the fourth connector 252 may communicate with the interface apparatus 300 independently to receive data from the interface apparatus 300 and transfer the received data to the micom 254 independently.

The slot part 253 may include a slot into which a card type memory 400c allowing 3G communications and the like can be inserted. The slot part 253 may include a SD card slot. Accordingly, if a card type memory is inserted into the slot part 253, the multimedia player 200 can communicate with the card type memory.

The micom 254 may request, if information about a destination is received when the navigation function is executed, a server (not shown) to perform route search, and receive a route from the server to guide a path based on the received route. At this time, the micon 254 may use map data of the card type memory 400a received from the interface apparatus 300 through the third connector 251.

The micom 254 may execute, if data stored in the external device 400b is received through the fourth connector 252, at least one function among functions that are executed on the external device 400b. The micom 254 may execute the navigation function using data stored in a SD card received through another USB communication line while controlling the display unit to output operation information according to the navigation function. Also, the micom 254 may execute the Carplay function using data stored in the external device 400b while controlling the display unit to output operation information according to the Carplay function.

The multimedia player 200 may further include a communication unit. The communication unit of the multimedia player 200 may communicate with a GPS (not shown), and transmit information about a current position received through the GPS to the controller 250. The GPS may receive position signals from a plurality of GPS satellites to calculate its own position (that is, a current position of the vehicle 1), and transmit information about the calculated position to the communication unit. Also, the GPS may include a GPS antenna (not shown) to receive satellite signals from the GPS satellites, an accelerometer (not shown) to measure acceleration of the vehicle 1, and an orientation sensor (not shown) to sense orientation of the vehicle 1. The GPS may transmit acceleration data and orientation data, in addition to information about a current position of the vehicle, to the communication unit.

The communication unit of the multimedia player 200 may communicate with the external device 400b and the server through a wired/wireless communication network. The wired/wireless communication network may be a broadcasting network, such as Transport Protocol Expert Group (TPEG) of DMB, Stream X-Machine (SXM), and Radio Data System (RDS). The server may communicate with the multimedia player 200, and if a route search request signal is received from the multimedia player 200, the server may search a route based on a current position of the vehicle 1 and a destination, and transmit information about the found route to the multimedia player 200.

The multimedia player 200 may further include a sound unit (not shown). The sound unit of the multimedia player 200 may output information about a route and driving information upon route guiding, as sound, and also output sound of music and images selected by a user.

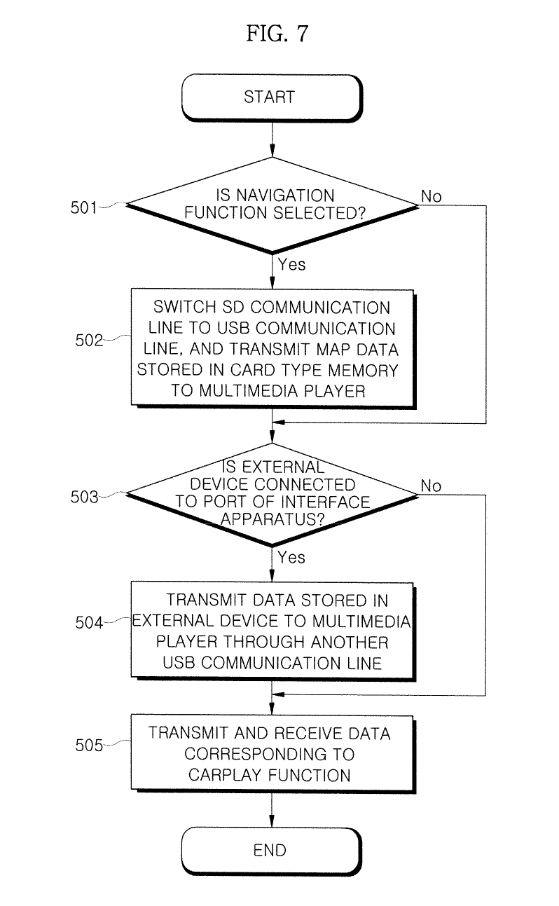

FIG. 7 is a flowchart chart illustrating a method of controlling a vehicle in which an interface apparatus according to an embodiment of the present disclosure and a multimedia player are installed. The method of controlling the vehicle will be described in detail with reference to FIGS. 6 to 10, below.

If the vehicle 1 (see FIG. 2) starts, a battery in the vehicle 1 may supply power to various electronic devices in the vehicle 1. At this time, the multimedia player 200 installed in the vehicle 1 may receive operating power, and then, the multimedia player 200 may display a home screen on the display unit.

Thereafter, if a user selects a function through the home screen, the multimedia player 200 may recognize the selected function and execute the recognized function. For example, if a DMB function is selected by the user, the multimedia player 200 may receive broadcasting signals, and output broadcasting images and broadcasting audio signals as images and sound. If a music play function is selected by the user, the multimedia player 200 may output music play signals as sound.

The multimedia player 200 may determine whether a navigation function is selected by the user, in operation 501. If the multimedia player 200 determines that the navigation function is selected by the user, the multimedia player 200 may execute the navigation function while displaying operation information for the navigation function. At this time, the multimedia player 200 may communicate with a GPS, and communicate with the interface apparatus 300 to receive map data from the SD card 400a that is a card type memory inserted into the interface apparatus 300. That is, the interface apparatus 300 may transmit, when the multimedia player 200 executes the navigation function, map data stored in the SD card 400a to the multimedia player 200. Transmitting the map data to the multimedia player 200 may include transmitting map data stored in the SD card 400a inserted into the slot part 310 of the interface apparatus 300 to the hub part 315 through a SD communication line. Then, the hub part 315 may switch the SD communication line to a USB communication line, and transmit the map data to the first connector 340a through the USB communication line, and the first connector 340a may transmit the map data to the third connector 251 electrically connected to the first connector 340a through a USB communication line, in operation 502. Then, the third connector 251 provided in the controller 250 of the multimedia player 200 may transmit the map data received from the interface apparatus 300 to the micom 254 of the multimedia player 200.

Thereafter, the multimedia player 200 may determine whether an external device 400b is connected to the port part 320 when the navigation function is executed, in operation 503. If the multimedia player 200 determines that the external device 400b is connected to the port part 320, the multimedia player 200 may transmit a signal for requesting data communications with the external device 400b to the interface apparatus 300. That is, if a smart phone as the external device 400b is connected to the port part 320 when the map data stored in the SD card 400a is provided, the interface apparatus 300 may transmit data stored in the smart phone 400b to the multimedia player 200 using the second connector 340b and the fourth connector 252 being a USB communication line that is different from the USB communication line of transmitting the map data, in operation 504.

Herein, transmitting the data stored in the external device 400b to the multimedia player 200 may include transmitting data stored in the external device 400b to the multimedia player 200 so that at least one function among a plurality of functions that are executed on the smart phone as the external device 400b is executed on the multimedia player 200.

Thereafter, the interface apparatus 300 may transmit and receive data corresponding to the Carplay function between the multimedia player 200 and the external device 400b until the external device 400b is disconnected from the interface apparatus 300, in operation 505.

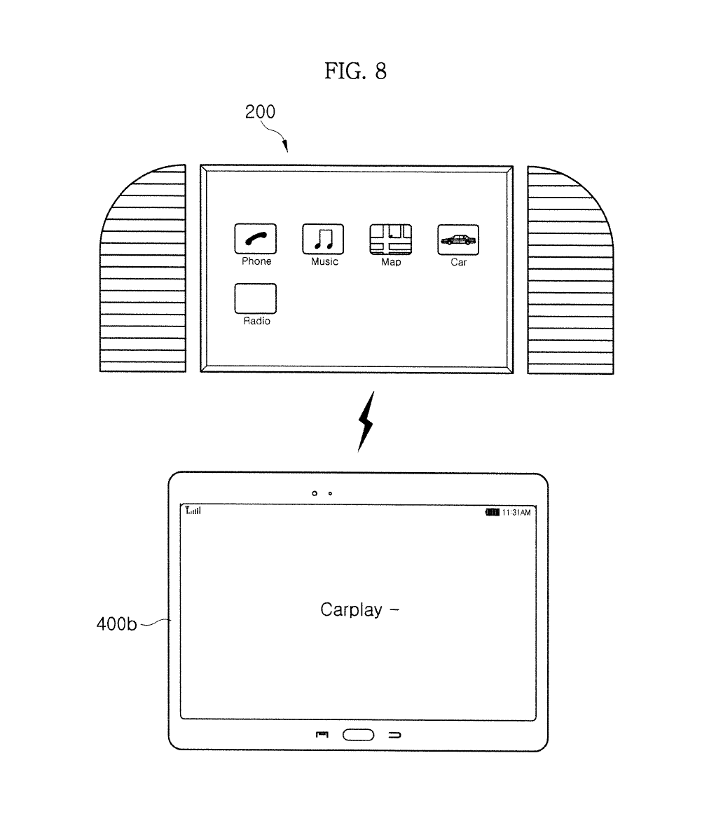

As shown in FIG. 8, if the smart phone as the external device 400b is connected to the port part 320, the interface apparatus 300 may enable communications between the multimedia player 200 and the smart phone. That is, the interface apparatus 300 may connect the multimedia player 200 installed in the vehicle 1 to a mobile communication terminal through a USB.

At this time, the multimedia player 200 may execute only the display function, and actual execution of the corresponding application, data processing, and communication may be executed on the smart phone 400b. Also, the multimedia player 200 may display only a function usable in the vehicle 1, instead of displaying the screen of the smart phone 400b as it is.

For example, the smart phone 400b may block reception of data for game applications, and transmit music data, video data, messenger applications, and the like, in consideration of a driver's safety, when the Carplay function is executed on the multimedia player 200. Also, when a messenger application is executed, the multimedia player 200 may output content as sound.

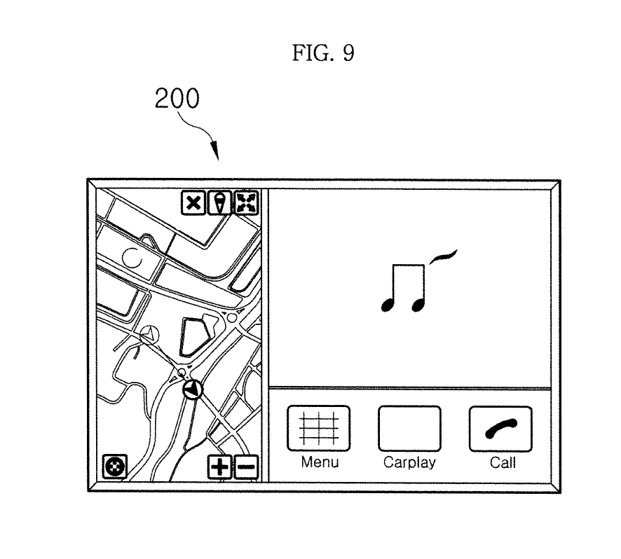

As shown in FIG. 9, if a signal for selecting a navigation function is received, the multimedia player 200 may request map data stored in the card type memory 400a. At this time, the interface apparatus 300 may read map data stored in the card type memory 400a according to the signal for selecting the navigation function through a SD communication line, and switch the SD communication line to a USB communication line to transfer the map data to the multimedia player 200 through the USB communication line.

If the map data is received, the multimedia player 200 may execute the navigation function using the map data and GPS data, and display operation information corresponding to the navigation function. At this time, the multimedia player 200 may display operation information related to the navigation function on a part of the display unit, and operation information related to another function on the remaining part of the display unit.

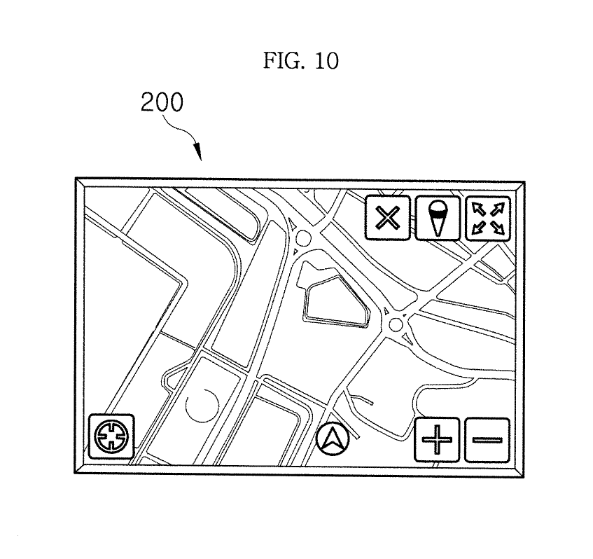

As shown in FIG. 10, if the navigation function is selected when a smart phone is connected to the interface apparatus 300, the multimedia player 200 may display only operation information related to the navigation function.

Also, if the smart phone is disconnected from the interface apparatus 300, the multimedia player 200 may receive map data through the USB communication line of the interface apparatus 300 to execute the navigation function while displaying only operation information related to the navigation function.

According to the embodiments of the present disclosure as described above, since the slot part for a card type memory (for example, a SD card), the USB port part, and the AUX terminal are arranged together, it is possible to improve the commercial value and design of the multimedia player (for example, an AVN system).

Additionally, by providing the slot part into which the card type memory storing map data can be inserted in the interface apparatus, it is possible to improve the design of the interface apparatus, and to ensure a space for a center fascia inside the vehicle. Also, by moving the slot part of the card type memory to a location that is not easily exposed in the interface apparatus, the card type memory can be prevented from being lost. Also, by storing map data in the card type memory, it is possible to reduce a time taken to update the AVN system, and to improve a user's convenience. Also, by switching the communication line of the card type memory to a USB communication line, map data can be provided to the multimedia player even when a mobile communication terminal is connected to the interface apparatus, so that the navigation function can be stably executed on the multimedia player.

Furthermore, since the slot part of the card type memory and the hub part are designed to be within a distance of 200 mm, an expensive cable for card type memory is not required, which leads to an effective reduction of manufacturing costs.

Thereby, the quality of the interface apparatus and the vehicle can be improved, which leads to improvement of the commercial value of the vehicle. Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. An interface apparatus of communicating with a multimedia player, comprising:
a slot part into which a card type memory is inserted;
a hub part connected to the slot part, and configured to switch a communication line of the card type memory to a Universal Serial Bus (USB) communication line;
a port part to which an external device allowing USB communications is connected;
a first connector connected to the hub part, and configured to transmit data stored in the card type memory to the multimedia player; and
a second connector connected to the port part, and configured to transmit data stored in the external device to the multimedia player.

2. The interface apparatus of claim 1, wherein each of the first connector and the second connector comprises a USB port having an independent USB communication line.

3. The interface apparatus of claim 1, wherein the card type memory is a Secure Digital (SD) card, and the slot part comprises a SD slot.

4. The interface apparatus of claim 1, wherein the first connector and the second connector are connected to the multimedia player through a cable or a connector.

5. The interface apparatus of claim 1, further comprising a terminal part configured to receive and output an audio signal.

6. A vehicle comprising:
a multimedia player; and
an interface apparatus configured to transmit data to the multimedia player,
wherein the interface apparatus comprises:
a slot part to which a card type memory storing map data is inserted;
a hub part configured to switch a communication line of the slot part to a Universal Serial Bus (USB) communication line; and
a first connector connected to the hub part, and configured to transmit data stored in the card type memory to the multimedia player.

7. The vehicle of claim 6, wherein the interface apparatus comprises:
a port part to which an external device allowing USB communications is connected; and
a second connector connected to the port part, and configured to transmit data stored in the external device to the multimedia player.

8. The vehicle of claim 7, wherein the multimedia player comprises a controller configured to perform USB communications with the interface apparatus, to receive data through the USB communications, and to control operation of the multimedia player based on the received data.

9. The vehicle of claim 8, wherein the controller comprises:
a third connector connected to the first connector, and configured to receive data stored in the card type memory;
a fourth connector connected to the second connector, and configured to receive data stored in the external device; and
a micom configured to receive at least one data between the data stored in the card type memory and the data stored in the external device.

10. The vehicle of claim 9, wherein the micom controls communications of the third connector and the fourth connector independently.

11. The vehicle of claim 9, wherein the controller further comprises a slot part into which the card type memory is inserted.

12. The vehicle of claim 9, wherein the multimedia player executes at least one function among functions of the external device connected to the fourth connector.

13. The vehicle of claim 6, wherein the multimedia player is connected to the interface apparatus through a cable or a connector.

14. The vehicle of claim 6, wherein the interface apparatus further comprises a terminal part configured to receive and output an audio signal.

15. The vehicle of claim 6, wherein the interface apparatus is positioned in a center fascia to be adjacent to the multimedia player.

16. A method of controlling an interface apparatus to transmit data to a multimedia player installed in a vehicle, comprising:
if a navigation function is executed on the multimedia player, receiving map data stored in a card type memory through a Secure Digital (SD) communication line; and
switching the SD communication line to a Universal Serial Bus (USB) communication line to transmit the map data to the multimedia player.

17. The method of claim 16, further comprising, if an external device is connected to a port part of the interface apparatus when the multimedia player executes the navigation function, transmitting data stored in the external device to the multimedia player through another USB communication line.

18. The method of claim 17, wherein the transmitting of the data stored in the external device comprises transmitting the data stored in the external device to the multimedia player so that at least one function among a plurality of functions that are executed on the external device is executed on the multimedia player.
